(19) United States
(12) Patent Application Publication
(10) Pub. No.: US 2021/0343027 A1
(43) Pub. Date: Nov. 4, 2021

(54) OBJECT TRACKING METHOD AND APPARATUS, STORAGE MEDIUM AND ELECTRONIC DEVICE

(71) Applicant: TENCENT TECHNOLOGY (SHENZHEN) COMPANY LIMITED, Shenzhen (CN)

(72) Inventors: Xiang Qi HUANG, Shenzhen (CN); Wen ZHOU, Shenzhen (CN); Yong Jun CHEN, Shenzhen (CN); Meng Yun TANG, Shenzhen (CN); Xiao Yun YAN, Shenzhen (CN); Yan Ping TANG, Shenzhen (CN); Si Jia TU, Shenzhen (CN); Peng Yu LENG, Shenzhen (CN); Shui Sheng LIU, Shenzhen (CN); Zhi Wei NIU, Shenzhen (CN); Chao DONG, Shenzhen (CN); Ming LU, Shenzhen (CN); Peng HE, Shenzhen (CN)

(73) Assignee: TENCENT TECHNOLOGY (SHENZHEN) COMPANY LIMITED, Shenzhen (CN)

(21) Appl. No.: 17/366,513

(22) Filed: Jul. 2, 2021

Related U.S. Application Data
(63) Continuation of application No. PCT/CN2020/102667, filed on Jul. 17, 2020.

(30) Foreign Application Priority Data
Jul. 31, 2019 (CN) 201910704621.0

(51) Int. Cl. G06T 7/246; G06T 7/73; G06K 9/00; G06K 9/62

(52) U.S. Cl. CPC G06T 7/248; G06T 7/74; G06T 2207/30241; G06K 9/6215; G06K 9/00758

(57) ABSTRACT

An object tracking method includes: obtaining at least one image acquired by at least one image acquisition device; obtaining a first appearance feature of a target object and a first spatial-temporal feature of the target object based on the at least one image; obtaining an appearance similarity and a spatial-temporal similarity between the target object and each global tracking object in a currently recorded global tracking object queue; based on determining that the target object matches a target global tracking object based on the appearance similarity and the spatial-temporal similarity, allocating a target global identifier corresponding to the target global tracking object to the target object; determining, using the target global identifier, a plurality of associated images acquired by a plurality of image acquisition devices associated with the target object; and generating, based on the plurality of associated images, a tracking trajectory matching the target object.

### CROSS-REFERENCE TO RELATED APPLICATION

This application is a bypass continuation application of International Application No. PCT/CN2020/102667, filed on Jul. 17, 2020 and entitled “OBJECT TRACKING METHOD AND APPARATUS, STORAGE MEDIUM, AND ELECTRONIC DEVICE”, which claims priority to Chinese Patent Application No. 2019107046210 filed with the China National Intellectual Property Administration on Jul. 31, 2019 and entitled “OBJECT TRACKING METHOD AND APPARATUS, STORAGE MEDIUM AND ELECTRONIC DEVICE”, the disclosures of which are herein incorporated by reference in their entireties.

### FIELD

The disclosure relates to the field of data monitoring, and in particular, to an object tracking method and apparatus, a storage medium and an electronic device.

### BACKGROUND

In order to achieve safety protection in public regions, video monitoring systems are generally installed in public regions. Through pictures obtained by the video monitoring systems, it is possible to realize intelligent pre-warning, timely warning during an incident, and efficient traceability after the incident for emergencies that occur in the public regions.

However, at present, in conventional video monitoring systems, only isolated pictures taken by a single camera can be obtained, and the pictures of each camera cannot be correlated. That is, in a case that a target object is found in a picture taken by a camera, only the position of the target object at that time can be determined, but the target object cannot be positioned and tracked in real time, which leads to the problem of poor accuracy of object tracking.

For the foregoing problem, no effective solution has been provided.

### SUMMARY

According to embodiments of the disclosure, provided are an object tracking method and apparatus, a storage medium and an electronic device.

An object tracking method, executed by an electronic device, the method including: obtaining at least one image acquired by at least one image acquisition device, the at least one image including a target object; obtaining, based on the at least one image, a first appearance feature of the target object and a first spatial-temporal feature of the target object; obtaining an appearance similarity and a spatial-temporal similarity between the target object and each global tracking object in a currently recorded global tracking object queue, the appearance similarity being a similarity between the first appearance feature of the target object and a second appearance feature of a global tracking object, and the spatial-temporal similarity being a similarity between the first spatial-temporal feature of the target object and a second spatial-temporal feature of the global tracking object; based on determining that the target object matches a target global tracking object in the global tracking object queue based on the appearance similarity and the spatial-temporal similarity, allocating a target global identifier corresponding to the target global tracking object to the target object; based on the target global identifier, determining a plurality of images acquired by a plurality of image acquisition devices, the plurality of images being associated with the target object; and generating, based on the plurality of associated images, a tracking trajectory matching the target object.

An object tracking apparatus, including: at least one memory configured to store program code; and at least one processor configured to read the program code and operate as instructed by the program code, the program code including: first obtaining code configured to cause at least one of the at least one processor to obtain at least one image acquired by at least one image acquisition device, the at least one image including a target object; second obtaining code configured to cause at least one of the at least one processor to obtain, based on the at least one image, a first appearance feature of the target object and a first spatial-temporal feature of the target object; third obtaining code configured to cause at least one of the at least one processor to obtain an appearance similarity and a spatial-temporal similarity between the target object and each global tracking object in a currently recorded global tracking object queue, the appearance similarity being a similarity between the first appearance feature of the target object and a second appearance feature of a global tracking object, and the spatial-temporal similarity being a similarity between the first spatial-temporal feature of the target object and a second spatial-temporal feature of the global tracking object; allocation code configured to cause at least one of the at least one processor to allocate, based on determining that the target object matches a target global tracking object in the global tracking object queue based on the appearance similarity and the spatial-temporal similarity, a target global identifier corresponding to the target global tracking object to the target object; first determining code configured to cause at least one of the at least one processor to determine, based on the target global identifier, a plurality of images acquired by a plurality of image acquisition devices, the plurality of images being associated with the target object; and generation code configured to cause at least one of the at least one processor to generate, based on the plurality of associated images, a tracking trajectory matching the target object.

A non-transitory computer-readable storage medium, the storage medium storing a computer program, the computer program, when run, performing the object tracking method.

An electronic device, including a memory, a processor, and a computer program stored in the memory and running on the processor, the processing performing the object tracking method through the computer program.

Details of one or more embodiments of the disclosure are provided in the accompanying drawings and descriptions below. Other features and advantages of the disclosure become obvious with reference to the specification, the accompanying drawings, and the claims.

### BRIEF DESCRIPTION OF THE DRAWINGS

The accompanying drawings described herein are intended to provide further understanding of the disclosure and constitute a part of the disclosure. Example embodiments of the disclosure and the description thereof are used for explaining the disclosure rather than constituting the improper limitation to the disclosure. In the accompanying drawings:

FIG. 1 is a schematic diagram of a network environment of an object tracking method according to an embodiment of the disclosure.

FIG. 2 is a flowchart of an object tracking method according to an embodiment of the disclosure.

FIG. 3 is a schematic diagram of an object tracking method according to an embodiment of the disclosure.

FIG. 4 is a schematic diagram of another object tracking method according to an embodiment of the disclosure.

FIG. 5 is a schematic diagram of still another object tracking method according to an embodiment of the disclosure.

FIG. 6 is a schematic diagram of yet another object tracking method according to an embodiment of the disclosure.

FIG. 7 is a schematic diagram of yet another object tracking method according to an embodiment of the disclosure.

FIG. 8 is a schematic structural diagram of an object tracking apparatus according to an embodiment of the disclosure.

FIG. 9 is a schematic structural diagram of an electronic device according to an embodiment of the disclosure.

### DETAILED DESCRIPTION

To make persons skilled in the art understand the solutions in the disclosure better, the following describes the technical solutions in the example embodiments of the disclosure with reference to the accompanying drawings. Apparently, the described embodiments are merely some but not all of the embodiments of the disclosure. All other embodiments obtained by a person of ordinary skill in the art based on the embodiments of the disclosure shall fall within the protection scope of the disclosure.

The terms such as “first” and “second” in this specification, the claims, and the foregoing accompanying drawings of the disclosure are intended to distinguish between similar objects rather than describe a particular sequence or a chronological order. It is to be understood that data used in this way is exchangeable in a proper case, so that the embodiments of the disclosure described herein may be implemented in an order different from the order shown or described herein. Moreover, the terms “include”, “contain” and any other variants mean to cover the non-exclusive inclusion, for example, a process, method, system, product, or device that includes a list of operations or units is not necessarily limited to those expressly listed operations or units, but may include other operations or units not expressly listed or inherent to such a process, method, system, product, or device.

### Definitions of Related Terms and Abbreviations

1) Trajectory: a movement trajectory of a person walking in a real building environment mapped onto an electronic map;

2) Intelligent security: it replaces passive defense of conventional security, realizes intelligent pre-warning, timely warning during an incident, and efficient traceability after the incident, and solves the current situations of passive defense and inefficient retrieval of conventional video monitoring systems.

3) Artificial Intelligence (AI) human form recognition: it is an AI video algorithm technology for identity recognition based on feature information of a person such as body shape, clothing, gait, and posture, for analyzing the feature information through a picture captured by a camera, comparing individual characters to distinguish which individuals in the picture belong to the same person, and performing personnel trajectory tracking tandem and other analyses based on the comparison.

4) Trajectory tracking: all the action paths of certain personnel within a monitoring range are tracked.

5) Building Information Modeling (BIM): the BIM technology is currently widely recognized by the industry on a global scale. It helps realize integration of building information. From the design, construction and operation of a building to the end of a life cycle of the building, different pieces of information are integrated in a three-dimensional modeling information database. A design team, a construction organization, a facility operation department and an owner, etc. work together based on BIM, which effectively improves working efficiency, saves resources, lowers the costs, and achieves sustainable development. While descriptions are mainly made herein by using BIM as an example, the disclosure is not limited to tracking an object in a building but may apply to any other application scenarios.

6) Electronic map: a building space is structured based on the BIM modeling, an Internet of Things device is directly displayed on a two-dimensional or three-dimensional map for users to operate and choose.

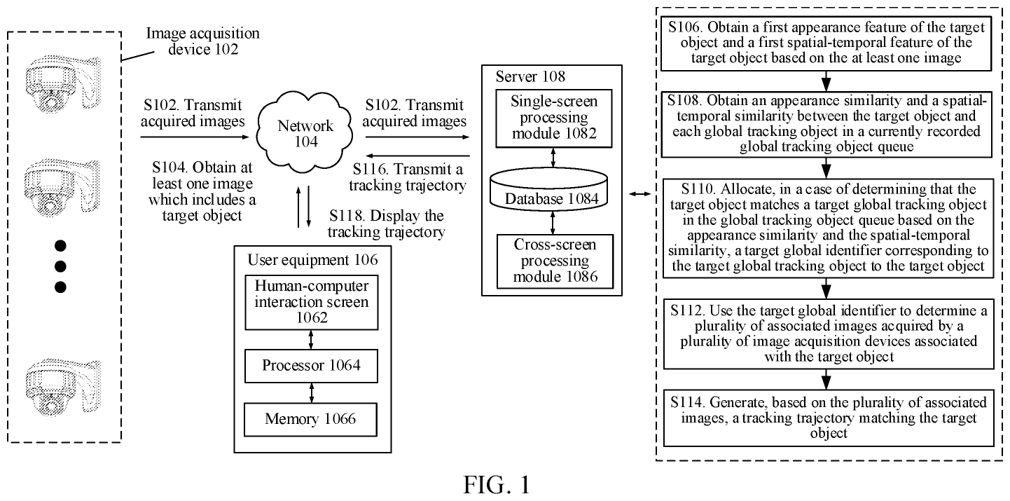

According to one aspect of embodiments of the disclosure, an object tracking method is provided. In an example embodiment, the object tracking method may be, but is not limited to, applied to a network environment where an object tracking system as shown in FIG. 1 is located. The object tracking system may include, but is not limited to: an image acquisition device 102, a network 104, a user equipment 106, and a server 108. The image acquisition device 102 is configured to acquire an image of a designated region, so as to monitor and track objects appearing in the region. The user equipment 106 includes a human-computer interaction screen 1062, a processor 1064, and a memory 1066. The human-computer interaction screen 1062 is configured to display the image acquired by the image acquisition device 102, and is further configured to obtain a human-computer interaction operation on the image. The processor 1064 is configured to determine a target object to be tracked in response to the human-computer interaction operation. The memory 1066 is configured to store the image. The server 108 includes a single-screen processing module 1082, a database 1084, and a cross-screen processing module 1086. The single-screen processing module 1082 is configured to obtain an image acquired by an image acquisition device, and perform feature extraction on the image to obtain an appearance feature and a spatial-temporal feature of a moving target object contained therein. The cross-screen processing module 1086 is configured to obtain processing results of the single-screen processing module 1082, and integrate the processing results to determine whether the target object is a global tracking object in the global tracking object queue stored in the database 1084. Based on determining that the target object matches the target global tracking object, a corresponding tracking trajectory is generated.

The specific process includes the following operations. Operation S102: The image acquisition device 102 transmits the acquired image to the server 108 through the network 104, and the server 108 stores the image in the database 1084.

Furthermore, operation S104: Obtain at least one image selected by the user equipment 106 through the human-computer interaction screen 1062, the at least one image including at least one target object. Then, operations S106-S114 are executed by the single-screen processing module 1082 and the cross-screen processing module 1086 to: obtain a first appearance feature of the target object and a first spatial-temporal feature of the target object based on the at least one image; obtain an appearance similarity and a spatial-temporal similarity between the target object and each global tracking object in a currently recorded global tracking object queue; based on determining that the target object matches a target global tracking object based on the appearance similarity and the spatial-temporal similarity, allocate a target global identifier corresponding to the target global tracking object to the target object, so that the target object establishes an association relationship with the target global tracking object; use the target global identifier to determine a plurality of associated images acquired by a plurality of image acquisition devices associated with the target object; and generate, based on the plurality of associated images, a tracking trajectory of the target object.

Operations S116-S118: The server 108 transmits the tracking trajectory to the user equipment 106 through the network 104, and displays the tracking trajectory of the target object in the user equipment 106.

In an example embodiment, when at least one image containing a target object acquired by at least one image acquisition device is obtained, the first appearance feature and the first spatial-temporal feature of the target object are extracted, so that an appearance similarity and a spatial-temporal similarity between the target object and each global tracking object in the global tracking object queue are determined through comparison, thereby determining whether the target object is a global tracking object based on the appearance similarity and the spatial-temporal similarity. When it is determined that the target object is the target global tracking object, a global identifier is allocated to the target object, so that all the associated images associated with the target object are obtained using the global identifier, thereby generating a tracking trajectory corresponding to the target object based on spatial-temporal features of the associated images. That is, upon acquisition of a target object, global search is carried out based on an appearance feature and a spatial-temporal feature of the target object. When the target global tracking object matching the target object is found, a global identifier of the target global tracking object is allocated to the target object, and linkage of associated images acquired by a plurality of associated image acquisition devices is triggered using the global identifier. Based on the associated images marked with the same global identifier, the tracking trajectory of the target object may be generated. The solution provided in an example embodiment is not based on a single reference to an independent position and thus realizes real-time positioning and tracking of the target object, thereby overcoming the problem of poor object tracking accuracy in the related art.

In an example embodiment, the user equipment may be, but is not limited to, a mobile phone, a tablet computer, a notebook computer, a Personal Computer (PC for short) and other terminal devices that support running application clients. The foregoing server and user equipment may, but are not limited to, implement data exchange through a network. The network may include, but is not limited to, a wireless network or a wired network. The wireless network includes: Bluetooth, Wi-Fi, and another network implementing wireless communication. The wired network may include, but is not limited to: a wide area network, a metropolitan area network, and a local area network. The foregoing is merely an example, and this is not limited in an example embodiment.

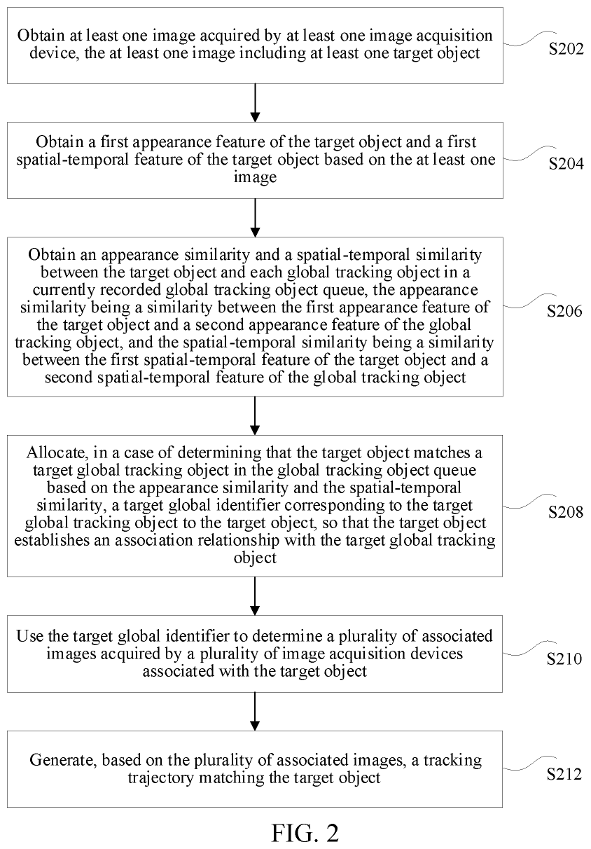

In an example embodiment, as shown in FIG. 2, the foregoing object tracking method includes the following operations:

S202: obtaining at least one image acquired by at least one image acquisition device, the at least one image including at least one target object;

S204: obtaining a first appearance feature of the target object and a first spatial-temporal feature of the target object based on the at least one image;

S206: obtaining an appearance similarity and a spatial-temporal similarity between the target object and each global tracking object in a currently recorded global tracking object queue, the appearance similarity being a similarity between the first appearance feature of the target object and a second appearance feature of the global tracking object, and the spatial-temporal similarity being a similarity between the first spatial-temporal feature of the target object and a second spatial-temporal feature of the global tracking object;

S208: allocating, based on determining that the target object matches a target global tracking object in the global tracking object queue based on the appearance similarity and the spatial-temporal similarity, a target global identifier corresponding to the target global tracking object to the target object, so that the target object establishes an association relationship with the target global tracking object;

S210: using the target global identifier to determine a plurality of associated images acquired by a plurality of image acquisition devices associated with the target object; and

S212: generating, based on the plurality of associated images, a tracking trajectory matching the target object.

In an example embodiment, the object tracking method may be, but is not limited to, applied to an object monitoring platform, which may be, but is not limited to, a platform application for real-time tracking and positioning of at least one selected target object based on images acquired by at least two image acquisition devices installed in the building. The image acquisition device may be, but is not limited to, a camera installed in the building, such as an infrared camera or other Internet of Things devices equipped with cameras. The building may be, but is not limited to, equipped with a map based on Building Information Modeling (BIM for short), such as an electronic map, in which the position of each Internet of Things device in the Internet of Things is marked and displayed, such as the position of the camera. In addition, in an example embodiment, the target object may be, but is not limited to, a moving object recognized in the image, such as a person to be monitored. Accordingly, the first appearance feature of the target object may include, but is not limited to, features extracted from a shape of the target object based on a Person Re-Identification (Re-ID for short) technology and a face recognition technology, such as height, body shape, clothing and other information. The image may be an image acquired by the image acquisition device from a discrete image in a predetermined period, or may be an image in a video recorded by the image acquisition device in real time. That is, the image source in an example embodiment may be an image set, or an image frame in the video. The image source is not limited in an example embodiment. In addition, the first spatial-temporal feature of the target object may include, but is not limited to, a latest acquired acquisition timestamp of the target object and a latest position of the target object. That is, by comparing the appearance feature and the spatial-temporal feature, it is determined from the global tracking object queue whether the current target object is marked as a global tracking object; if yes, a global identifier is allocated to the current target object, and the associated images locally acquired by the associated image acquisition device are obtained through direct linkage based on the global identifier, so as to determine a position movement path of the target object directly using the associated images. Accordingly, the effect of quickly and accurately generating its tracking trajectory may be achieved.

The object tracking method shown in FIG. 2 may be, but not limited to, used in the server 108 shown in FIG. 1. After the server 108 obtains the images returned by each image acquisition device 102 and the target object determined by the user equipment 106, whether to allocate a global identifier to the target object is determined by comparing the appearance similarity and the spatial-temporal similarity, so as to link a plurality of associated images corresponding to the global identifier to generate the tracking trajectory of the target object. Accordingly, the effect of real-time tracking and positioning of at least one target object across devices may be achieved.

In an example embodiment, before the obtaining at least one image acquired by at least one image acquisition device, the method may also include, but is not limited to: obtaining an image acquired by each image acquisition device in a target building and an electronic map created based on BIM for the target building; marking a position of each image acquisition device in the target building on the electronic map; and generating a global tracking object queue in the target building based on the acquired image.

When a central node server has not generated a global tracking object queue, the global tracking object queue may be constructed based on a first identified object in the acquired image. Furthermore, when the global tracking object queue includes at least one global tracking object, if the target object is acquired, the appearance feature and the spatial-temporal feature of the target object may be compared with those of the at least one global tracking object, to determine whether the target object matches the at least one global tracking object based on the appearance similarity and the spatial-temporal similarity obtained through comparison. When the two match, the association relationship between the target object and the global tracking object is established by allocating a global identifier to the target object.

In an example embodiment, the appearance similarity between the target object and each global tracking object may include, but is not limited to: comparing the first appearance feature of the target object with the second appearance feature of the global tracking object; and obtaining a feature distance between the target object and the global tracking object as the appearance similarity between the target object and the global tracking object. The appearance feature may include, but is not limited to: height, body shape, clothing, hairstyle and other features. The foregoing is merely an example, and this is not limited in an example embodiment.

In an example embodiment, the first appearance feature and second appearance feature may be, but are not limited to, multi-dimensional appearance features, and a cosine distance or a Euclidean distance between the first appearance feature and second appearance feature is obtained as the feature distance therebetween, i.e., the appearance similarity. Furthermore, in an example embodiment, it is possible to use, but not limited to, a non-normalized Euclidean distance. The foregoing are only examples. An example embodiment may also use, but not limited to, other distance calculation modes to determine a similarity between the multi-dimensional appearance features, which is not limited in an example embodiment.

In addition, in an example embodiment, upon obtaining of the image acquired by the image acquisition device, it is possible to use, but not limited to, the single-screen processing module to detect a moving object contained in the image through a target detection technology. The target detection technology may include, but is not limited to: Single Shot Multibox Detector (SSD), You Only Look Once (YOLO) and other technologies. Furthermore, the detected moving object is tracked and calculated using a tracking algorithm, and a local identifier is allocated to the moving object. The tracking algorithm may include, but is not limited to, a correlation filter algorithm (Kernel Correlation Filter, KCF for short), and a tracking algorithm based on a deep neural network, such as SiameseNet. While determining a target bounding box where the moving object is located, an appearance feature of the moving object is extracted based on the Person Re-Identification (Re-ID for short) technology and the face recognition technology, and body key points of the moving object are detected using related algorithms such as openpose or maskrcnn.

Then, information such as a local identifier of a person, a body bounding box, an extracted appearance feature, and body key points obtained in the foregoing process are pushed to the cross-screen processing module to facilitate integrating and comparing the global information.

The algorithms in the foregoing embodiments are all examples, and this is not limited in an example embodiment.

In an example embodiment, the spatial-temporal similarity between the target object and each global tracking object may include, but is not limited to: obtaining a latest first spatial-temporal feature of the target object (i.e., a latest detected acquisition timestamp and position information of the target object), and a latest second spatial-temporal feature of the global tracking object (i.e., a latest detected acquisition timestamp and position information of the global tracking object); and combining time and position information to determine a spatial-temporal similarity between the target object and the global tracking object.

In an example embodiment, the basis for reference in determination of the spatial-temporal similarity may include, but is not limited to, at least one of the following: a latest time difference that occurs, whether the latest time difference appears in images acquired by the same image acquisition device, and whether different image acquisition devices are adjacent (or abutting), and whether there is a photographing overlap region. Specifically, the following may be included.

1) The same object cannot appear in different positions at the same time.

2) When the object disappears, the longer the object disappears is, the lower the confidence level of the previously detected position information is.

3) For the photographing overlap region, it is determined from affine transformation between ground planes that the position on a ground plane may be mapping to a physical world coordinate system in a unified manner, or may be a relative conversion between overlapping camera picture coordinate systems, and this is not limited in an example embodiment.

4) The distance between objects appearing in the same image acquisition device may be, but is not limited to, the distance between two body bounding boxes. This distance does not simply consider the center point of the bounding box, but also considers the influence of the size of the bounding box on similarity.

In an example embodiment, the imaging using plane projection in the physical world to the image acquired by the image acquisition device satisfies the property of affine transformation, which may model the conversion relationship between the actual physical coordinate system of the earth plane and the image coordinate system. At least three pairs of feature points need to be calibrated beforehand to complete the calculation of an affine transformation model. In general, it is assumed that a human body is standing on the ground, that is, human feet are located above the ground plane. If the feet are visible in the image, an image position of a foot feature point may be converted to a global physical position. The same method may also be applied to realize the relative coordinate conversion between the images acquired by the image acquisition devices between the cameras with ground photographing overlap regions. The foregoing is only one dimension for reference in the coordinate conversion process, and the processing process in an example embodiment is not limited thereto.

In an example embodiment, for a target object and a global tracking object, the appearance similarity and spatial-temporal similarity between the target object and the global tracking object may be subjected to, but is not limited to, weighted summation, to obtain a similarity between the target object and the global tracking object. Furthermore, it is determined, based on the similarity, whether the target object needs to be allocated with a global identifier corresponding to the global tracking object, to globally search the target object based on the global identifier and obtain all the associated images. Changes in the moving position of the target object may be based on all the associated images, thereby generating a tracking trajectory for real-time tracking and positioning.

In addition, in an example embodiment, for M target objects and N global tracking objects in the global tracking object queue, it is possible to, but not limited to, use optimal data matching calculated according to the Hungarian algorithm with weight, to allocate corresponding global identifiers to the M target objects after the similarity matrix (M×N) is determined based on the appearance similarity and the spatial-temporal similarity, so as to achieve the purpose of improving the matching efficiency.

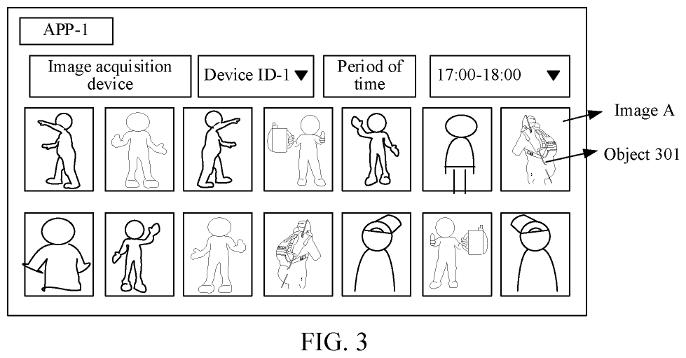

In an example embodiment, the obtaining at least one image acquired by at least one image acquisition device may include, but is not limited to: selecting an image from all candidate images presented on a display interface of an object monitoring platform (such as APP-1), and then taking an object contained in the image as a target object. For example, FIG. 3 shows all images acquired by an image acquisition device during a time period of 17:00-18:00, and an object 301 contained in an image A is determined as a target object through a human-computer interaction operation (for example, operations such as check and click). The foregoing is only an example, and this is not limited in an example embodiment. For example, there may be one or more target objects, and the display interface may also select and switch to present images acquired by different image acquisition devices in different time periods.

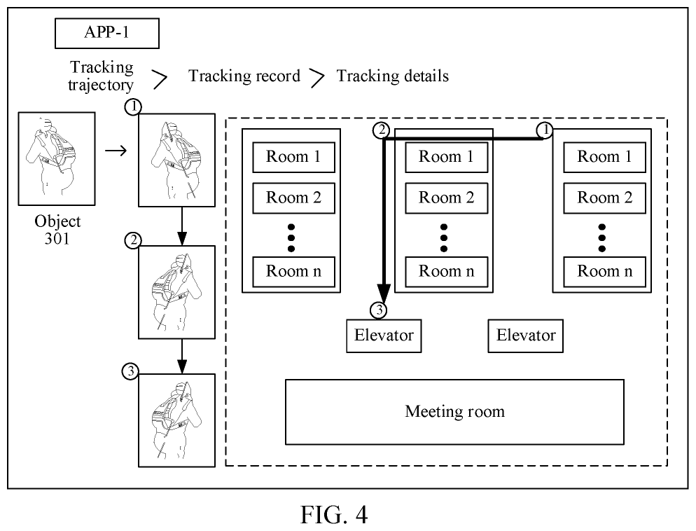

In an example embodiment, when it is determined through comparison based on the appearance similarity and the spatial-temporal similarity that the target object matches the target global tracking object in the global tracking object queue, a target global identifier is allocated to the target object, and all associated images having the target global identifier are obtained. The associated images are arranged based on the spatial-temporal features of the associated images, and the positions of the acquired associated images are marked, based on an acquisition timestamp, in the map corresponding to the target building, to generate the tracking trajectory of the target object to realize global tracking and monitoring effect. For example, as shown in FIG. 4, it is determined based on the associated images that the target object (such as the selected object 301) appears in three positions shown in FIG. 4, and then is marked in the map corresponding to the target building based on the three positions, to generate the tracking trajectory as shown in FIG. 4.

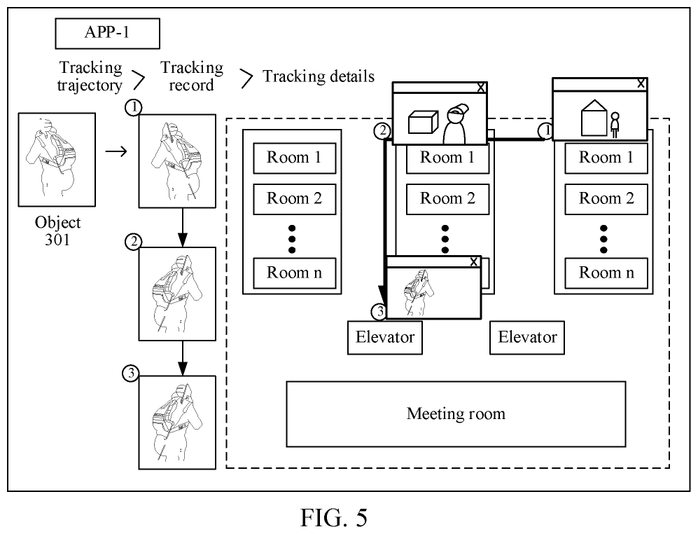

Furthermore, in an example embodiment, the tracking track may include, but is not limited to, operation controls. In response to operations performed on the operation controls, the image or video acquired at the position may be displayed. As shown in FIG. 5, icons corresponding to the operation controls may be digital icons “\textcircled{1}, \textcircled{2}, and \textcircled{3}” as shown in the figure. After the digital icons are clicked, it is possible to, but is not limited to, present the acquired pictures shown in FIG. 5, so as to flexibly view the monitored content at the corresponding position.

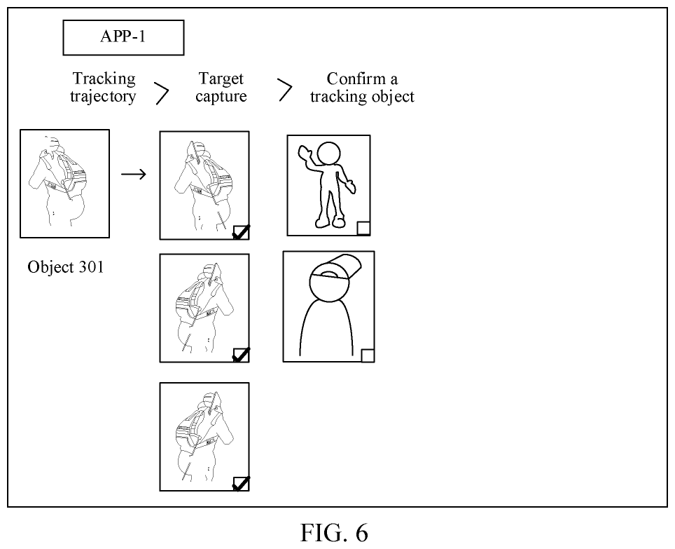

In an example embodiment, when the target object is determined, if it is intended to expand the search range, a threshold of similarity comparison may be adjusted, and a user's inverse selection operation is increased, so that the search target may be confirmed in the expanded range through human eyes. As shown in FIG. 6, the user may check the related object in images captured in each image acquisition device (e.g., confirm the target object), so as to better assist the algorithm in completing a search result.

In addition, in an example embodiment, when at least one image is obtained to determine the target object, the method may also include, but is not limited to, comparing objects contained in images acquired by adjacent image acquisition devices with fields of view overlapping, to determine whether the objects are the same object, thereby establishing the association relationship between the objects.

According to the implementations provided by the disclosure, upon acquisition of a target object, global search is carried out based on an appearance feature and a spatial-temporal feature of the target object. When the target global tracking object matching the target object is found, a global identifier of the target global tracking object is allocated to the target object, and linkage of associated images acquired by a plurality of associated image acquisition devices is triggered using the global identifier. The tracking trajectory of the target object may be generated based on the associated images marked with the same global identifier. The solution provided in an example embodiment is not based on a single reference to an independent position and thus realizes real-time positioning and tracking of the target object, thereby overcoming the problem of poor object tracking accuracy in the related art.

In an example embodiment, the generating, based on the plurality of associated images, a tracking trajectory matching the target object includes the following operations:

S1: obtaining a third spatial-temporal feature of the target object in each of the plurality of associated images;

S2: arranging the plurality of associated images based on the third spatial-temporal feature to obtain an image sequence; and

S3: marking, based on the image sequence, a position where the target object appears in a map corresponding to a target building where the at least one image acquisition device is installed, to generate the tracking trajectory of the target object.

In an example embodiment, based on determining that the target object is to be tracked, and the target object matches the target global tracking object in the global tracking object queue, a target global identifier is allocated to the target object. Accordingly, the target object may globally search all the acquired images based on the target global identifier, to obtain a plurality of associated images, and obtain a third spatial-temporal feature of the target object contained in each associated image, e.g., including an acquisition timestamp when the target object is acquired, and the position of the target object. Thus, the positions where the target objects appear are arranged according to the indication of the acquisition timestamp in the third spatial-temporal feature, and the positions are marked on the map, so as to generate the real-time tracking trajectory of the target objects.

In an example embodiment, the position of the target object indicated in the spatial-temporal feature may be, but is not limited to, jointly determined according to the position of the image acquisition device that acquires the target object and the image position of the target object in the image. In addition, information for distinguishing whether the image acquisition devices are adjacent and whether the fields of view overlap, etc. is also needed to accurately locate the position of the target object.

Specifically, it is described in conjunction with FIG. 4, it is assumed that three sets of associated images are obtained, and the positions where the target objects appear are sequentially determined as: the first set of associated images indicates that the position where the target object appears the first time is next to room 1 in a third column, the second set of associated images indicates that the position where the target object appears the second time is next to room 1 in a second column, and the third set of associated images indicates that the position where the target object appears the third time is at an elevator on the left. The positions may be marked on a BIM electronic map corresponding to the building, and a trajectory (e.g., the trajectory with an arrow shown in FIG. 4) may be generated as the tracking trajectory of the target object.

The plurality of associated images may be, but are not limited to, different images acquired by a plurality of image acquisition devices, and may also be different images extracted from video stream data acquired by the plurality of image acquisition devices. That is, the set of images may be, but is not limited to, a set of discrete images acquired by an image acquisition device, or a video. The foregoing are only examples, and is not limited in an example embodiment.

In an example embodiment, after the marking, based on the image sequence, a position where the target object appears in a map corresponding to a target building where the at least one image acquisition device is installed, to generate the tracking trajectory of the target object, the method further includes the following operations:

S4: displaying the tracking trajectory, the tracking trajectory including a plurality of operation controls, and the operation controls having a mapping relationship with the position where the target object appears; and

S5: displaying, in response to an operation performed on the operation controls, an image of the target object acquired at a position indicated by the operation controls.

The operation controls may be, but are not limited to, interaction controls set for a human-computer interaction interface, and the human-computer interaction operations corresponding to the operation controls may include, but are not limited to: a single-click operation, a double-click operation, a sliding operation, and the like. Upon obtaining of the operation performed on the operation controls, in response to the operation, a display window may pop up to display an image acquired at that position, such as a screenshot or a video.

Specifically, with reference to FIG. 5, assuming that the foregoing scene describe din FIG. 4 is still taken as an example for description, icons corresponding to the operation control may be digital icons “\textcircled{1}, \textcircled{2}, and \textcircled{3}” shown in the figure (e.g., shown in the tracking details). When the digital icons are clicked, the acquired pictures or videos as shown in FIG. 5 may be presented (e.g., adjacent to the digital icons). Therefore, it may be possible to directly provide the pictures when the target object passes through the position, so as to fully replay the actions of the target object.

According to the embodiments provided in the disclosure, when the target object to be tracked is determined, and the target object matches the target global tracking object, a target global identifier matching the target global tracking object is allocated to the target object. Accordingly, global linkage and search of all the acquired images may be realized using the target global identifier, to obtain a plurality of acquired associated images of the target object. Furthermore, a moving path of the target object is determined based on the spatial-temporal features of target objects in the plurality of associated images, to ensure that the tracking trajectory of the target object is generated quickly and accurately, thereby achieving the purpose of positioning and tracking the target object.

In an example embodiment, after the obtaining an appearance similarity and a spatial-temporal similarity between the target object and each global tracking object in a currently recorded global tracking object queue, the method further includes the following operation:

S1: sequentially taking each global tracking object in the global tracking object queue as a current global tracking object, to execute the following operations:

S12: performing weighted calculation on the appearance similarity and the spatial-temporal similarity of the current global tracking object to obtain a current similarity between the target object and the current global tracking object; and

S14: determining that the current global tracking object is the target global tracking object when the current similarity is greater than a first threshold.

In order to ensure the comprehensiveness and accuracy of positioning and tracking, in an example embodiment, the target object needs to be compared with each global tracking object included in the global tracking object queue, so as to determine the target global tracking object matching the target object.

In an example embodiment, the appearance similarity between the target object and the global tracking object may be, but is not limited to, determined through the following operations: obtaining a second appearance feature of the current global tracking object; obtaining a feature distance between the second appearance feature and the first appearance feature, the feature distance including at least one of the following: a cosine distance and a Euclidean distance; and taking the feature distance as the appearance similarity between the target object and the current global tracking object.

Furthermore, in an example embodiment, it is possible to use, but not limited to, a non-normalized Euclidean distance. The appearance feature may be, but is not limited to, multi-dimensional features extracted from a shape of the target object based on a Person Re-Identification (Re-ID for short) technology and a face recognition technology, such as height, body shape, clothing, hair style and other information. Furthermore, the multi-dimensional feature in the first appearance feature is converted into a first appearance feature vector, and correspondingly, the multi-dimensional feature in the second appearance feature is converted into a second appearance feature vector. Then, the first appearance feature vector and the second appearance feature vector are compared to obtain a vector distance (such as the Euclidean distance). Moreover, the vector distance is taken as the appearance similarity of the two objects.

In an example embodiment, the spatial-temporal similarity between the target object and the global tracking object may be determined through, but is not limited to, the following operations: before the performing weighted calculation on the appearance similarity and the spatial-temporal similarity of the current global tracking object to obtain a current similarity between the target object and the current global tracking object, determining a positional relationship between a first image acquisition device that obtains the latest first spatial-temporal feature of the target object and a second image acquisition device that obtains a latest second spatial-temporal feature of the current global tracking object; obtaining a time difference (or direct time difference) between a first acquisition timestamp and a second acquisition timestamp, the first acquisition timestamp being a first acquisition timestamp (e.g., an acquisition timestamp that is first in order among first acquisition timestamps in the latest first spatial-temporal feature of the target object, or any given acquisition timestamp among the first acquisition timestamps in the latest first spatial-temporal feature of the target object) in the latest first spatial-temporal feature of the target object, and the second acquisition timestamp being a time difference between second acquisition timestamps in the latest second spatial-temporal feature of the current global tracking object; and determining a spatial-temporal similarity between the target object and the current global tracking object based on the positional relationship and the time difference.

That is, a spatial-temporal similarity between the target object and the current global tracking object is determined by combining the positional relationship and the time difference. The basis for reference in determination of the spatial-temporal similarity may include, but is not limited to, at least one of the following: a latest time difference that occurs, whether the latest time difference appears in images acquired by the same image acquisition device, and whether different image acquisition devices are adjacent (or abutting) and whether there is a photographing overlap region.

According to the embodiments provided in the disclosure, the appearance similarity is obtained by comparing the appearance features, and the spatial-temporal similarity is obtained by comparing the spatial-temporal features, and the appearance similarity and the spatial-temporal similarity are further merged to obtain a similarity between the target object and the global tracking object. In this way, it is possible to determine the association relationship between the target object and the global tracking object by combining the appearance and two dimensions, i.e., time and space, to quickly and accurately determine the global tracking object matching the target object, so as to improve the matching efficiency, and then shorten the duration for obtaining the associated image to generate the tracking trajectory, thereby achieving the effect of improving the efficiency of trajectory generation.

In an example embodiment, the determining a spatial-temporal similarity between the target object and the current global tracking object based on the positional relationship and the time difference includes:

1) determining the spatial-temporal similarity between the target object and the current global tracking object based on a first target value when the time difference is greater than a second threshold, the first target value being less than a third threshold;

2) when the time difference is less than the second threshold and greater than zero, and the positional relationship indicates that the first image acquisition device and the second image acquisition device are the same device, obtaining a first distance between a first image acquisition region containing the target object in the first image acquisition device and a second image acquisition region containing the current global tracking object in the second image acquisition device, and determining the spatial-temporal similarity based on the first distance;

3) when the time difference is less than the second threshold and greater than zero, and the positional relationship indicates that the first image acquisition device and the second image acquisition device are adjacent devices, performing coordinate conversion on each pixel of the first image acquisition region containing the target object in the first image acquisition device, to obtain a first coordinate in a first target coordinate system; performing coordinate conversion on each pixel of the second image acquisition region containing the current global tracking object in the second image acquisition device, to obtain a second coordinate in the first target coordinate system; and obtaining a second distance between the first coordinate and the second coordinate, and determining the spatial-temporal similarity based on the second distance; and

4) when the time difference is equal to zero, and the positional relationship indicates that the first image acquisition device and the second image acquisition device are the same device, or when the time difference is equal to zero, and the positional relationship indicates that the first image acquisition device and the second image acquisition device are adjacent devices but fields of view do not overlap, or when the positional relationship indicates that the first image acquisition device and the second image acquisition device are non-adjacent devices, determining the spatial-temporal similarity between the target object and the current global tracking object based on a second target value, the second target value being greater than a fourth threshold.

The greater the time difference is, the lower the confidence level of the corresponding position relationship is; and the same object cannot appear in different image acquisition devices with the positions not adjacent at the same time. Objects acquired by different image acquisition devices with the positions adjacent to each other and the fields of view overlap with each other may be compared to determine whether the objects are the same object, so as to facilitate establishing associations between the objects.

Based on the above factors that need to be considered, in this example, the spatial-temporal similarity may be determined through, but not limited to, two dimensions, i.e., time and space. Specifically, it may be described in conjunction with Table 1, in which it is assumed that a first image acquisition device is represented by Cam_1, a second image acquisition device is represented by Cam_2, and a time difference between the first image acquisition device and the second image acquisition device is represented by t_diff.

TABLE 1

| | Positional relationship | | | |
|---|---|---|---|---|
| | | Cam_1! = Cam_2 | Cam_1! = Cam_2 | |
| | | (abutting, | (abutting, and | |
| | | and the | the fields | Cam_1! = Cam_2 |
| Time | | fields of | of view | (no |
| difference | Cam_1 == Cam_2 | view overlap) | do not overlap) | abutting) |
| t_diff == 0 | INF_MAX | Coordinate | INF_MAX | INF_MAX |
| | | conversion | | |
| | | between | | |
| | | images to | | |
| | | determine | | |
| | | a distance | | |
| 0 < t_diff ≤ T1 | bbox_distance | Constant c or | Constant c or | |
| | in an image | global_distance | global_distance | |
| T1 < t_diff ≤ T2 | Constant C | | | |
| T2 < t_diff | | Constant C | Constant C | |

For illustrative purposes, it is assumed that the second threshold may be, but is not limited to, T1 or T2 shown in Table 1, the first target value may be, but is not limited to, INF_MAX or the constant c shown in Table 1, and the second target value may be, but is not limited to, INF_MAX shown in Table 1. Specifically, reference may be made to the following example situations:

1) when the time difference is t_diff>T2, and the positional relationship indicates that Cam_1==Cam_2, or Cam_1!=Cam_2, but Cam_1 and Cam_2 are adjacent devices (also called abutting), the spatial-temporal similarity between the target object and the current global tracking object is determined based on the constant c.

2) When the time difference is t_diff>T2, and the positional relationship indicates that Cam_1 is a non-adjacent device (no abutting), the spatial-temporal similarity between the target object and the current global tracking object is determined based on INF_MAX, where INF_MAX indicates infinitely great, and the spatial-temporal similarity determined on this basis indicates that the spatial-temporal similarity between the target object and the current global tracking object is extremely small.

3) When the time difference is T1<t_diff≤T2, and the positional relationship indicates that Cam_1=Cam_2, the spatial-temporal similarity between the target object and the current global tracking object is determined based on the constant c.

4) When the time difference is T1<t_diff≤T2, and the positional relationship indicates that Cam_1!=Cam_2, but Cam_1 and Cam_2 are adjacent devices (also called abutting), the spatial-temporal similarity between the target object and the current global tracking object is determined based on the constant c or a global coordinate distance (global_distance). The global coordinate distance (global_distance) is used for indicating that image coordinates of each pixel in the body bounding box (such as a virtual space) corresponding to objects in two image acquisition devices are converted to global coordinates in a first target coordinate system (such as a physical coordinate system corresponding to the actual space), and then the distance (global_distance) between the target object and the current global tracking object is obtained in the same coordinate system, to determine the spatial-temporal similarity between the target object and the current global tracking object based on the distance.

5) When the time difference is T1<t_diff≤T2, and the positional relationship indicates that Cam_1 is a non-adjacent device (no abutting), the spatial-temporal similarity between the target object and the current global tracking object is determined based on INF_MAX, where INF_MAX indicates infinitely great, and the spatial-temporal similarity determined on this basis indicates that the spatial-temporal similarity between the target object and the current global tracking object is extremely small.

6) When the time difference is 0<t_diff≤T1, and the positional relationship indicates that Cam_1!=Cam_2, but Cam_1 and Cam_2 are adjacent devices (also called abutting), the spatial-temporal similarity between the target object and the current global tracking object is determined based on the constant c or a global coordinate distance (global_distance). The global coordinate distance (global_distance) is used for indicating that image coordinates of each pixel in the body bounding box (such as a virtual space) corresponding to objects in two image acquisition devices are converted to global coordinates in a first target coordinate system (such as a physical coordinate system corresponding to the actual space), and then the distance (global_distance) between the target object and the current global tracking object is obtained in the same coordinate system, to determine the spatial-temporal similarity between the target object and the current global tracking object based on the distance.

7) When the time difference is 0<t_diff≤T1, and the positional relationship indicates that Cam_1==Cam_2, the spatial-temporal similarity between the target object and the current global tracking object is determined based on a bounding box distance (bbox_distance) in the image. In the above case, if the target object and the current global tracking object are determined to be in the same coordinate system, the image distance (i.e., bbox_distance) between pixels in the body bounding box corresponding to the two objects may be directly obtained, to determine the spatial-temporal similarity between the target object and the current global tracking object based on the distance. The bounding box distance (bbox_distance) may be, but is not limited to, related to the area of the body bounding box, and the calculation mode may refer to the related art, which is not repeated here in an example embodiment.

8) When the time difference is 0<t_diff≤T1, and the positional relationship indicates that Cam_1 is a non-adjacent device (no abutting), the spatial-temporal similarity between the target object and the current global tracking object is determined based on INF_MAX, where INF_MAX indicates infinitely great, and the spatial-temporal similarity determined on this basis indicates that the spatial-temporal similarity between the target object and the current global tracking object is extremely small.

9) When the time difference is t_diff==0, and the positional relationship indicates that Cam_1==Cam_2, or Cam_1!=Cam_2, but Cam_1 and Cam_2 are adjacent devices (also called abutting) and the fields of view overlap, or Cam_1 is a non-adjacent device (no abutting), the spatial-temporal similarity between the target object and the current global tracking object is determined based on INF_MAX, where INF_MAX indicates infinitely great, and the spatial-temporal similarity determined on this basis indicates that the spatial-temporal similarity between the target object and the current global tracking object is extremely small.

10) When the time difference is t_diff==0, and the positional relationship indicates that Cam_1!=Cam_2, but Cam_1 and Cam_2 are adjacent devices (also called abutting) and the fields of view overlap, a coordinate system mapping relationship between two image acquisition devices based on at least three pairs of feature points in images acquired by the two image acquisition devices. Coordinates of the two image acquisition devices are mapped to the same coordinate system further based on the coordinate system mapping relationship, and the spatial-temporal similarity between the target object and the current global tracking object is determined based on the distance calculated according to the coordinates in the same coordinate system.

According to the example embodiments provided in the disclosure, the spatial-temporal similarity between the target object and the current global tracking object is determined by combining the relationships of time and space positions, to ensure a global tracking object that is more closely associated with the target object, so as to accurately obtain a plurality of associated images, thereby ensuring that a tracking trajectory with a higher degree of matching with the target object is generated based on the plurality of associated images, and ensuring the accuracy and effectiveness of real-time positioning and tracking.

In an example embodiment, after the obtaining at least one image acquired by at least one image acquisition device, the method further includes the following operations:

S1: determining a set of images containing the target object from the at least one image;

S2: converting coordinates of each pixel in images acquired by the at least two image acquisition devices into coordinates in a second target coordinate system when at least two image acquisition devices that are adjacent devices among the plurality of image acquisition devices acquire the set of images, and the fields of view overlap;

S3: determining, based on the coordinates in the second target coordinate system, a distance between the target objects contained in the images acquired by the at least two image acquisition devices; and

S4: determining that the target objects contained in the images acquired by the at least two image acquisition devices are the same object when the distance is less than a target threshold.

In an example embodiment, after a set of images containing the target objects is acquired, the relationship between the target objects may be determined based on, but not limited to, the positional relationship between the image acquisition devices that acquire the set of images, for example, whether the image acquisition devices are the same object. In addition, it is also possible to determine whether the target objects in a plurality of images are the same object based on body key points in the appearance feature. The specific comparison method may refer to a detection algorithm of body key points provided in the related art, which is not repeated here.

For the set of images, it is possible to, but is not limited to, first perform coordinate conversion on the contained target objects based on the positional relationship between the image acquisition devices, so as to perform uniform distance comparison.

For the target objects appearing in the same image acquisition device, a distance may be calculated directly using the coordinates in its own coordinate system, without coordinate conversion. For the non-adjacent image acquisition devices, or for image acquisition devices that are located adjacent to each other but have no overlapping fields of view, coordinate position mapping is performed on a target object in an image acquired by each image acquisition device, for example, the coordinates in the virtual space are mapped to the coordinates in the real space. That is, the real-world coordinates of each image acquisition device are determined using a positional correspondence between a BIM model map corresponding to a target building where the image acquisition device is located and the image acquisition device. Furthermore, the global coordinates of the target object in the real space are determined based on the real-world coordinates of the image acquisition device and the positional correspondence, so as to facilitate calculation and determination of the distance.

Furthermore, for the image acquisition devices that are located adjacent to each other but have no overlapping fields of view in an example embodiment, coordinate position mapping may be, but is not limited to, performed on a target object in an image acquired by each image acquisition device: 1) the coordinates in the virtual space are mapped to the coordinates in the real space; and 2) the coordinates are mapped to the coordinate system of the same image acquisition device in a unified mode. For example, the image coordinates (xA, yA) of the target objects under a camera A are mapped to an image coordinate system of a camera B, and then the distance between the target objects in the same coordinate system is compared. When the distance is less than a threshold, the target objects may be regarded as the same object, and the data association between the two cameras is completed. In a similar fashion, the association between a plurality of cameras may be completed to form a global mapping relationship.

According to the embodiments provided in the disclosure, the target objects in the images acquired by different image acquisition devices are compared through coordinate mapping conversion to determine whether the target objects are the same object, so as to establish associations with the target objects under different image acquisition devices, and also establish associations with the plurality of image acquisition devices.

In an example embodiment, before the converting coordinates of each pixel in images acquired by the at least two image acquisition devices into coordinates in a second target coordinate system, the method further includes the following operations:

S1: when the at least two image acquisition devices are adjacent devices and the fields of view overlap, caching the images acquired by the at least two image acquisition devices in a first period of time, and generating a plurality of trajectories associated with the target object;

S2: obtaining a trajectory similarity between any two of the plurality of trajectories; and

S3: when the trajectory similarity is greater than or equal to a fifth threshold; determining that data acquired by the two image acquisition devices is not synchronized.

A plurality of image acquisition devices are often deployed in the object monitoring platform, and due to various reasons, for example, the sensor's own system time is not synchronized, or network transmission delays or upstream algorithm processing delays, etc., resulting in a larger error in real-time data association across image acquisition devices.

In order to overcome the problems, the characteristics of the target objects acquired by the image acquisition devices with a photographing overlap region have the same movement trajectory. In an example embodiment, for the case of adjacent devices and overlapping fields of view, it is possible to, but is not limited to, cache the image data, that is, the image data acquired by at least two image acquisition devices that are adjacent to each other and have overlapping fields of view within a period of time is cached, and curve shape matching is performed on the movement trajectories of the objects recorded in the cached image data, to obtain a trajectory similarity. When the trajectory similarity is greater than a threshold, it indicates that the two associated trajectory curves are not similar, and on this basis, it is prompted that the problem of data out-of-synchronization occurs in the corresponding image acquisition device, and needs to be adjusted in time to control the error.

According to the disclosure, improved solutions are provided. The image data acquired by the image acquisition devices that are located adjacent to each other and have overlapping fields of view are cached within a period of time through a data cache mechanism, so as to use the cached image data to obtain the movement trajectories of the objects moving therein, and the problem of data out-of-synchronization caused by whether each image acquisition device is interfered is monitored by performing curve shape matching on the movement trajectories. In this way, prompt information may be generated in time through a monitoring result, to avoid an error caused by time misalignment when the data at a single time point is directly matched.

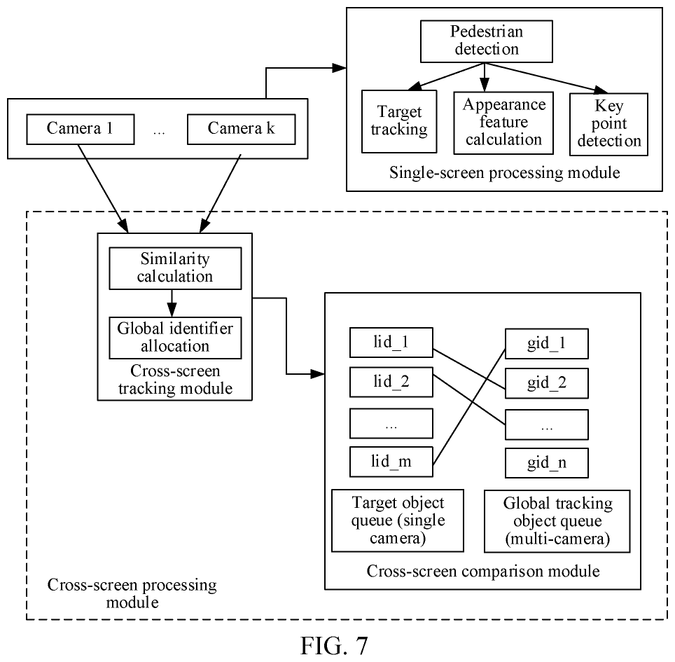

Specifically, a description is provided with reference to the example shown in FIG. 7:

Among a plurality of images captured by a plurality of cameras (such as a camera 1 to a camera k), a single-screen processing module in a server obtains at least one image transmitted by one camera, and target object detection is performed on the image using the target detection technology (for example, SSD, YOLO and other methods). Then tracking is carried out using tracking algorithms (such as KCF and other related filtering algorithms, and deep neural network-based tracking algorithms, such as SiameseNet), to obtain a local identifier (such as lid_1) corresponding to the target object. Furthermore, the appearance feature (such as the re-id feature) is calculated while obtaining the target bounding box, and the body key points are detected at the same time (related algorithms such as openpose or maskrcnn may be used).

Furthermore, a first appearance feature and a first spatial-temporal feature of the target object are obtained based on the detection operation result. In a cross-screen comparison module in the cross-screen processing module, the first appearance feature and the first spatial-temporal feature of the target object are correspondingly compared with a second appearance feature and a second spatial-temporal feature of each global tracking object in the global tracking object queue. In the cross-screen tracking module, the similarity between objects is obtained based on the appearance similarity and the spatial-temporal similarity obtained through the comparison, and based on the comparison between the similarity and the threshold, it is determined whether to allocate a global identifier, such as gid_1, of the global tracking object to the current target object (gid_1).

When it is determined to allocate the global identifier, global search is performed based on the global identifier (such as gid_1), to obtain a plurality of associated images associated with the target object, thereby generating a tracking trajectory of the target object based on spatial-temporal features of the plurality of associated images.

For ease of description, the foregoing method embodiments are described as a series of action combinations. However, a person skilled in the art understands that the disclosure is not limited to the described sequence of the actions, because some operations may be performed in another sequence or performed at the same time according to the disclosure. In addition, a person skilled in the art also appreciates that all the embodiments described in the specification are preferred embodiments, and the related actions and modules are not necessarily mandatory to the disclosure.

FIG. 2 is a schematic flowchart of an object tracking method according to an embodiment. It is to be understood that, although each operation of the flowcharts in FIG. 2 is displayed sequentially according to arrows, the operations are not necessarily performed according to an order indicated by arrows. Unless otherwise explicitly specified in the disclosure, execution of the operations is not strictly limited, and the operations may be performed in other sequences. In addition, at least some operations in FIG. 2 and FIG. 2 may include a plurality of suboperations or a plurality of stages. The suboperations or the stages are not necessarily performed at the same moment, and instead may be performed at different moments. A performing sequence of the suboperations or the stages is not necessarily performed in sequence, and instead may be performed in turn or alternately with another operation or at least some of suboperations or stages of the another operation.

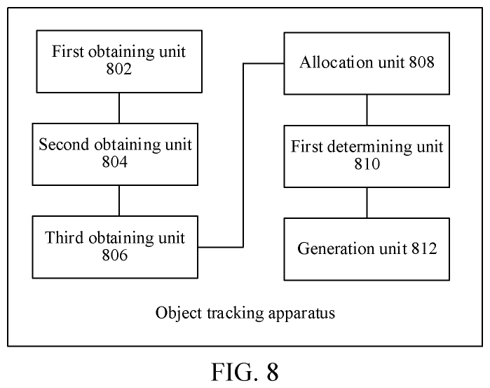

According to another aspect of the embodiments of the disclosure, an object tracking apparatus for implementing the object tracking method is further provided. As shown in FIG. 8, the apparatus includes:

1) a first obtaining unit 802, configured to obtain at least one image acquired by at least one image acquisition device, the at least one image including at least one target object;

2) a second obtaining unit 804, configured to obtain a first appearance feature of the target object and a first spatial-temporal feature of the target object based on the at least one image;

3) a third obtaining unit 806, configured to obtain an appearance similarity and a spatial-temporal similarity between the target object and each global tracking object in a currently recorded global tracking object queue, the appearance similarity being a similarity between the first appearance feature of the target object and a second appearance feature of the global tracking object, and the spatial-temporal similarity being a similarity between the first spatial-temporal feature of the target object and a second spatial-temporal feature of the global tracking object;

4) an allocation unit 808, configured to allocate, based on determining that the target object matches a target global tracking object in the global tracking object queue based on the appearance similarity and the spatial-temporal similarity, a target global identifier corresponding to the target global tracking object to the target object, so that the target object establishes an association relationship with the target global tracking object;

5) a first determining unit 810, configured to use the target global identifier to determine a plurality of associated images acquired by a plurality of image acquisition devices associated with the target object; and

6) a generation unit 812, configured to generate, based on the plurality of associated images, a tracking trajectory matching the target object.

In an example embodiment, the object tracking apparatus may be, but is not limited to, applied to an object monitoring platform, which may be, but is not limited to, a platform application for real-time tracking and positioning of at least one selected target object based on images acquired by at least two image acquisition devices installed in the building. The image acquisition device may be, but is not limited to, a camera installed in the building, such as an infrared camera or other Internet of Things devices equipped with cameras. The building may be, but is not limited to, equipped with a map based on Building Information Modeling (BIM for short), such as an electronic map, in which the position of each Internet of Things device in the Internet of Things is marked and displayed, such as the position of the camera. In addition, in an example embodiment, the target object may be, but is not limited to, a moving object recognized in the image, such as a person to be monitored. Accordingly, the first appearance feature of the target object may include, but is not limited to, features extracted from a shape of the target object based on a Person Re-Identification (Re-ID for short) technology and a face recognition technology, such as height, body shape, clothing and other information. The image may be an image acquired by the image acquisition device from a discrete image in a predetermined period, or may be an image in a video recorded by the image acquisition device in real time. That is, the image source in an example embodiment may be an image set, or an image frame in the video. This is not limited in an example embodiment. In addition, the first spatial-temporal feature of the target object may include, but is not limited to, a latest acquired acquisition timestamp of the target object and a latest position of the target object. That is, by comparing the appearance feature and the spatial-temporal feature, it is determined from the global tracking object queue whether the current target object is marked as a global tracking object, if yes, a global identifier is allocated to the current target object, and the associated images locally acquired by the associated image acquisition device are obtained through direct linkage based on the global identifier, so as to determine a position movement path of the target object directly using the associated images. Accordingly, achieving the effect of quickly and accurately generating its tracking trajectory may be achieved.

The object tracking apparatus shown in FIG. 8 may be, but not limited to, used in the server 108 shown in FIG. 1. After the server 108 obtains the images returned by each image acquisition device 102 and the target object determined by the user equipment 106, whether to allocate a global identifier to the target object is determined by comparing the appearance similarity and the spatial-temporal similarity, so as to link a plurality of associated images corresponding to the global identifier to generate the tracking trajectory of the target object. Accordingly, the effect of real-time tracking and positioning of at least one target object across devices may be achieved.

In an example embodiment, the generation unit 812 includes:

1) a first obtaining module, configured to obtain a third spatial-temporal feature of the target object in each of the plurality of associated images;

2) an arranging module, configured to arrange the plurality of associated images based on the third spatial-temporal feature to obtain an image sequence; and

3) a marking module, configured to mark, based on the image sequence, a position where the target object appears in a map corresponding to a target building where the at least one image acquisition device is installed, to generate the tracking trajectory of the target object.

An embodiment in this solution can, but is not limited to, refer to the foregoing embodiments, and this is not limited in an example embodiment.

In an example embodiment, the apparatus further includes:

1) a first display module, configured to display the tracking trajectory after marking, based on the image sequence, the position where the target object appears in the map corresponding to the target building where the at least one image acquisition device is installed, to generate the tracking trajectory of the target object, the tracking trajectory including a plurality of operation controls, and the operation controls having a mapping relationship with the position where the target object appears; and

2) a second display module, configured to display, in response to an operation performed on the operation controls, an image of the target object acquired at a position indicated by the operation controls.

An embodiment in this solution can, but is not limited to, refer to the foregoing embodiments, and this is not limited in an example embodiment.

In an example embodiment, the apparatus further includes:

1) a processing unit, configured to sequentially take each global tracking object in the global tracking object queue as a current global tracking object to execute the following operations after obtaining the appearance similarity and the spatial-temporal similarity between the target object and each global tracking object in the currently recorded global tracking object queue:

S1: performing weighted calculation on the appearance similarity and the spatial-temporal similarity of the current global tracking object to obtain a current similarity between the target object and the current global tracking object; and

S2: determining that the current global tracking object is the target global tracking object when the current similarity is greater than a first threshold.

An embodiment in this solution can, but is not limited to, refer to the foregoing embodiments, and this is not limited in an example embodiment.

In an example embodiment, the processing unit is further configured to:

S1: obtain a second appearance feature of the current global tracking object before performing weighted calculation on the appearance similarity and the spatial-temporal similarity of the current global tracking object to obtain the current similarity between the target object and the current global tracking object;

S2: obtain a feature distance between the second appearance feature and the first appearance feature, the feature distance including at least one of the following: a cosine distance and a Euclidean distance; and

S3: take the feature distance as the appearance similarity between the target object and the current global tracking object.

An embodiment in this solution can, but is not limited to, refer to the foregoing embodiments, and this is not limited in an example embodiment.

In an example embodiment, the processing unit is further configured to:

S1: determine a positional relationship between a first image acquisition device that obtains a latest first spatial-temporal feature of the target object and a second image acquisition device that obtains a latest second spatial-temporal feature of the current global tracking object before performing weighted calculation on the appearance similarity and the spatial-temporal similarity of the current global tracking object to obtain the current similarity between the target object and the current global tracking object;

S2: obtain a time difference (or direct time difference) between a first acquisition timestamp and a second acquisition timestamp, the first acquisition timestamp being a first acquisition timestamp in the latest first spatial-temporal feature of the target object, and the second acquisition timestamp being a time difference between second acquisition timestamps in the latest second spatial-temporal feature of the current global tracking object; and

S3: determine a spatial-temporal similarity between the target object and the current global tracking object based on the positional relationship and the time difference.

An embodiment in this solution can, but is not limited to, refer to the foregoing embodiments, and this is not limited in an example embodiment.

In an example embodiment, the processing unit determines a spatial-temporal similarity between the target object and the current global tracking object based on the positional relationship and the time difference through the following operations:

1) determining the spatial-temporal similarity between the target object and the current global tracking object based on a first target value when the time difference is greater than a second threshold, the first target value being less than a third threshold;

2) when the time difference is less than the second threshold and greater than zero, and the positional relationship indicates that the first image acquisition device and the second image acquisition device are the same device, obtaining a first distance between a first image acquisition region containing the target object in the first image acquisition device and a second image acquisition region containing the current global tracking object in the second image acquisition device, and determining the spatial-temporal similarity based on the first distance;

3) when the time difference is less than the second threshold and greater than zero, and the positional relationship indicates that the first image acquisition device and the second image acquisition device are adjacent devices, performing coordinate conversion on each pixel of the first image acquisition region containing the target object in the first image acquisition device, to obtain a first coordinate in a first target coordinate system; performing coordinate conversion on each pixel of the second image acquisition region containing the current global tracking object in the second image acquisition device, to obtain a second coordinate in the first target coordinate system; and obtaining a second distance between the first coordinate and the second coordinate, and determining the spatial-temporal similarity based on the second distance; and

4) when the time difference is equal to zero, and the positional relationship indicates that the first image acquisition device and the second image acquisition device are the same device, or when the time difference is equal to zero, and the positional relationship indicates that the first image acquisition device and the second image acquisition device are adjacent devices but fields of view do not overlap, or when the positional relationship indicates that the first image acquisition device and the second image acquisition device are non-adjacent devices, determining the spatial-temporal similarity between the target object and the current global tracking object based on a second target value, the second target value being greater than a fourth threshold.

An embodiment in this solution can, but is not limited to, refer to the foregoing embodiments, and this is not limited in an example embodiment.

In an example embodiment, the apparatus further includes:

1) a second determining unit, configured to determine a set of images containing the target object from the at least one image after obtaining the at least one image acquired by the at least one image acquisition device;

2) a conversion unit, configured to convert, when there are at least two image acquisition devices that are adjacent devices among the plurality of image acquisition devices that acquire the set of images, and the fields of view overlap, coordinates of each pixel in images acquired by the at least two image acquisition devices into coordinates in a second target coordinate system;

3) a third determining unit, configured to determine, based on the coordinates in the second target coordinate system, a distance between the target objects contained in the images acquired by the at least two image acquisition devices; and

4) a fourth determining unit, configured to determine, when the distance is less than a target threshold, that the target objects contained in the images acquired by the at least two image acquisition devices are the same object.

An embodiment in this solution can, but is not limited to, refer to the foregoing embodiments, and this is not limited in an example embodiment.

In an example embodiment, the apparatus further includes:

1) a cache unit, configured to cache, when the at least two image acquisition devices are adjacent devices and the fields of view overlap, the images acquired by the at least two image acquisition devices in a first period of time, and generate a plurality of trajectories associated with the target object before converting the coordinates of each pixel in images acquired by the at least two image acquisition devices into the coordinates in a second target coordinate system;

2) a fourth obtaining unit, configured to obtain a trajectory similarity between any two of the plurality of trajectories; and

3) a fifth determining unit, configured to determine, when the trajectory similarity is greater than or equal to a fifth threshold, that data acquired by the two image acquisition devices is not synchronized.

An embodiment in this solution can, but is not limited to, refer to the foregoing embodiments, and this is not limited in an example embodiment.

In an example embodiment, the apparatus further includes:

1) a fifth obtaining unit, configured to obtain, before obtaining the at least one image acquired by the at least one image acquisition device, images acquired by all image acquisition devices in a target building where the at least one image acquisition device is installed; and

2) a construction unit, configured to construct, when the global tracking object queue is not generated, the global tracking object queue based on the images acquired by all the image acquisition devices in the target building.

An embodiment in this solution can, but is not limited to, refer to the foregoing embodiments, and this is not limited in an example embodiment.

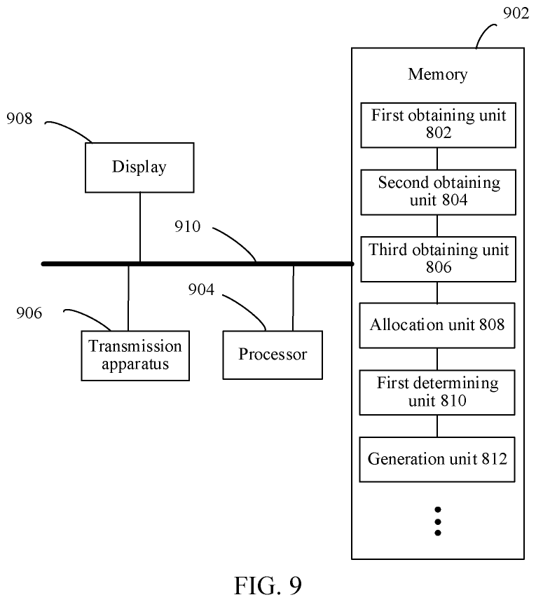

According to yet another aspect of the embodiments of the disclosure, an electronic device for implementing the object tracking method is further provided. As shown in FIG. 9, the electronic device includes a memory 902 and a processor 904, the memory 902 storing a computer program, and the processor 904 being configured to perform operations in any method embodiment through the computer program.

In an example embodiment, the electronic device may be located in at least one of a plurality of network devices of a computer network.

In an example embodiment, the processor may be configured to perform the following operations through the computer program:

S1: obtaining at least one image acquired by at least one image acquisition device, the at least one image including at least one target object;

S2: obtaining a first appearance feature of the target object and a first spatial-temporal feature of the target object based on the at least one image;

S3: obtaining an appearance similarity and a spatial-temporal similarity between the target object and each global tracking object in a currently recorded global tracking object queue, the appearance similarity being a similarity between the first appearance feature of the target object and a second appearance feature of the global tracking object, and the spatial-temporal similarity being a similarity between the first spatial-temporal feature of the target object and a second spatial-temporal feature of the global tracking object;

S4: allocating, based on determining that the target object matches a target global tracking object in the global tracking object queue based on the appearance similarity and the spatial-temporal similarity, a target global identifier corresponding to the target global tracking object to the target object, so that the target object establishes an association relationship with the target global tracking object;

S5: using the target global identifier to determine a plurality of associated images acquired by a plurality of image acquisition devices associated with the target object; and

S6: generating, based on the plurality of associated images, a tracking trajectory matching the target object.

In an example embodiment, a person of ordinary skill in the art may understand that the structure shown in FIG. 9 is only for illustration, and the electronic device may also be a smart phone (such as an Android phone, an iOS phone, etc.), a tablet computer, a palm computer, and a Mobile Internet Device (MID), PAD and other terminal devices. FIG. 9 does not limit the structure of the electronic device. For example, the electronic device may further include more or fewer components (such as a network interface) than those shown in FIG. 9, or have a configuration different from that shown in FIG. 9.

The memory 902 may be configured to store a software program and modules, such as program instructions/modules corresponding to the object tracking method and apparatus in the embodiments of the disclosure. The processor 904 executes various function applications and data processing by running the software program stored in the memory 902 and modules, to realize the object tracking method. The memory 902 may include a high-speed random memory, and may also include a non-volatile memory, for example, one or more magnetic storage apparatuses, a flash memory, or another nonvolatile solid-state memory. In some embodiments, the memory 902 may further include memories remotely disposed relative to the processor 904, and the remote memories may be connected to a terminal through a network. Examples of the network include, but are not limited to, the Internet, an intranet, a local area network, a mobile communication network, and a combination thereof. As an example, as shown in FIG. 9, the memory 902 may include, but is not limited to, the first obtaining unit 802, the second obtaining unit 804, the third obtaining unit 806, the first determining unit 810, and the generating unit 1812 in the object tracking apparatus. In addition, the memory may also include, but is not limited to, other module units in the object tracking apparatus, and details are not repeated in this example.

In an example embodiment, a transmission apparatus 906 is configured to receive or transmit data through a network. Specific examples of the network may include a wired network and a wireless network. In an example, the transmission apparatus 906 includes a network interface controller (NIC). The NIC may be connected to another network device and a router by using a network cable, so as to communicate with the Internet or a local area network. In an example, the transmission apparatus 906 is a radio frequency (RF) module, which communicates with the Internet in a wireless manner.

In addition, the electronic device further includes: a display 908 configured to display information such as at least one image or a target object; and a connection bus 910 configured to connect module components in the electronic device.

According to still another aspect of the embodiments of the disclosure, a storage medium is further provided. The storage medium stores a computer program, the computer program being configured to perform operations in any one of the foregoing method embodiments when run.

In an example embodiment, the storage medium may be configured to store a computer program used for performing the following operations:

S1: obtaining at least one image acquired by at least one image acquisition device, the at least one image including at least one target object;

S2: obtaining a first appearance feature of the target object and a first spatial-temporal feature of the target object based on the at least one image;

S3: obtaining an appearance similarity and a spatial-temporal similarity between the target object and each global tracking object in a currently recorded global tracking object queue, the appearance similarity being a similarity between the first appearance feature of the target object and a second appearance feature of the global tracking object, and the spatial-temporal similarity being a similarity between the first spatial-temporal feature of the target object and a second spatial-temporal feature of the global tracking object;

S4: allocating, based on determining that the target object matches a target global tracking object in the global tracking object queue based on the appearance similarity and the spatial-temporal similarity, a target global identifier corresponding to the target global tracking object to the target object, so that the target object establishes an association relationship with the target global tracking object;

S5: using the target global identifier to determine a plurality of associated images acquired by a plurality of image acquisition devices associated with the target object; and

S6: generating, based on the plurality of associated images, a tracking trajectory matching the target object.

In an example embodiment, a person of ordinary skill in the art would understand that all or some of the operations of the methods in the foregoing embodiments may be implemented by a program instructing relevant hardware of the terminal device. The program may be stored in a non-volatile computer-readable storage medium. when the program is executed, the processes of the embodiments of the foregoing method may be included. References to the memory, the storage, the database, or other medium used in the embodiments provided in the disclosure may all include a non-volatile or a volatile memory. The non-volatile memory may include a read-only memory (ROM), a programmable ROM (PROM), an electrically programmable ROM (EPROM), an electrically erasable programmable ROM (EEPROM), or a flash memory. The volatile memory may include a RAM or an external cache. By way of description rather than limitation, the RAM may be obtained in a plurality of forms, such as a static RAM (SRAM), a dynamic RAM (DRAM), a synchronous DRAM (SDRAM), a double data rate SDRAM (DDRSDRAM), an enhanced SDRAM (ESDRAM), a synchlink (Synchlink) DRAM (SLDRAM), a rambus (Rambus) direct RAM (RDRAM), a direct rambus dynamic RAM (DRDRAM), and a rambus dynamic RAM (RDRAM).

The sequence numbers of the embodiments of the disclosure are merely for the description purpose but do not imply the preference among the embodiments.

When the integrated unit in the foregoing embodiments is implemented in a form of a software functional unit and sold or used as an independent product, the integrated unit may be stored in the foregoing computer-readable storage medium. Based on such an understanding, the technical solutions of the disclosure essentially, or the part contributing to the related art, or all or some of the technical solutions may be presented in the form of a software product. The computer software product is stored in the storage medium, and includes several instructions for instructing one or more computer devices (which may be a personal computer, a server, a network device, or the like) to perform all or some of the operations of the methods described in the embodiments of the disclosure.

In the foregoing embodiments of the disclosure, the descriptions of the embodiments have different focuses. For a part that is not detailed in an embodiment, reference may be made to the relevant description of other embodiments.

In the several embodiments provided in the disclosure, it is to be understood that, the disclosed client may be implemented in another manner. The apparatus embodiments described above are merely examples. For example, the division of the units is merely the division of logic functions, and may use other division manners during actual implementation. For example, a plurality of units or components may be combined, or may be integrated into another system, or some features may be omitted or not performed. In addition, the coupling, or direct coupling, or communication connection between the displayed or discussed components may be the indirect coupling or communication connection by means of some interfaces, units, or modules, and may be electrical or of other forms.

The units described as separate components may or may not be physically separated, and the components displayed as units may or may not be physical units, and may be located in one place or may be distributed over a plurality of network units. Some or all of the units may be selected according to actual needs to achieve the objectives of the solutions of the embodiments.

In addition, functional units in the embodiments of the disclosure may be integrated into one processing unit, or each of the units may be physically separated, or two or more units may be integrated into one unit. The integrated unit may be implemented in the form of hardware, or may be implemented in a form of a software functional unit.

At least one of the components, elements, modules or units described herein may be embodied as various numbers of hardware, software and/or firmware structures that execute respective functions described above, according to an exemplary embodiment. For example, at least one of these components, elements or units may use a direct circuit structure, such as a memory, a processor, a logic circuit, a look-up table, etc. that may execute the respective functions through controls of one or more microprocessors or other control apparatuses. Also, at least one of these components, elements or units may be specifically embodied by a module, a program, or a part of code, which contains one or more executable instructions for performing specified logic functions, and executed by one or more microprocessors or other control apparatuses. Also, at least one of these components, elements or units may further include or implemented by a processor such as a central processing unit (CPU) that performs the respective functions, a microprocessor, or the like. Two or more of these components, elements or units may be combined into one single component, element or unit which performs all operations or functions of the combined two or more components, elements of units. Also, at least part of functions of at least one of these components, elements or units may be performed by another of these components, element or units. Further, although a bus is not illustrated in some of block diagrams, communication between the components, elements or units may be performed through the bus. Functional aspects of the above exemplary embodiments may be implemented in algorithms that execute on one or more processors. Furthermore, the components, elements or units represented by a block or processing operations may employ any number of related art techniques for electronics configuration, signal processing and/or control, data processing and the like.

The foregoing descriptions are only example implementations of the disclosure. A person of ordinary skill in the art may make some improvements and modifications without departing from the principle of the disclosure and the improvements and modifications shall fall within the protection scope of the disclosure.

What is claimed is:

1. An object tracking method, executed by an electronic device, the method comprising:
obtaining at least one image acquired by at least one image acquisition device, the at least one image comprising a target object;
obtaining, based on the at least one image, a first appearance feature of the target object and a first spatial-temporal feature of the target object;
obtaining an appearance similarity and a spatial-temporal similarity between the target object and each global tracking object in a currently recorded global tracking object queue, the appearance similarity being a similarity between the first appearance feature of the target object and a second appearance feature of a global tracking object, and the spatial-temporal similarity being a similarity between the first spatial-temporal feature of the target object and a second spatial-temporal feature of the global tracking object;
based on determining that the target object matches a target global tracking object in the global tracking object queue based on the appearance similarity and the spatial-temporal similarity, allocating a target global identifier corresponding to the target global tracking object to the target object;
based on the target global identifier, determining a plurality of images acquired by a plurality of image acquisition devices, the plurality of images being associated with the target object; and
generating, based on the plurality of associated images, a tracking trajectory matching the target object.

2. The method according to claim 1, wherein the generating the tracking trajectory comprises:
obtaining a third spatial-temporal feature of the target object in each of the plurality of associated images;
arranging the plurality of associated images based on the third spatial-temporal feature to obtain an image sequence; and
marking, based on the image sequence, a position where the target object appears in a map corresponding to a location in which the at least one image acquisition device is installed, to generate the tracking trajectory of the target object.

3. The method according to claim 2, further comprising, after the marking:
displaying the tracking trajectory, the tracking trajectory comprising a plurality of operation controls, and the plurality of operation controls having a mapping relationship with the position where the target object appears; and
displaying, in response to an operation performed on an operation control of the plurality of operation controls, an image of the target object acquired at a position indicated by the operation control.

4. The method according to claim 1, wherein the determining that the target object matches the target global tracking object comprises:
with respect to each global tracking object in the global tracking object queue, performing weighted calculation on the appearance similarity and the spatial-temporal similarity of a current global tracking object to obtain a current similarity between the target object and the current global tracking object; and
determining that the current global tracking object is the target global tracking object based on the current similarity being greater than a first threshold.

5. The method according to claim 4, further comprising, prior to the performing the weighted calculation:
obtaining a second appearance feature of the current global tracking object;
obtaining a feature distance between the second appearance feature and the first appearance feature; and
determining the feature distance as the appearance similarity between the target object and the current global tracking object.

6. The method according to claim 4, further comprising, prior to the performing weighted calculation:
determining a positional relationship between a first image acquisition device that obtains a latest first spatial-temporal feature of the target object and a second image acquisition device that obtains a latest second spatial-temporal feature of the current global tracking object;
obtaining a time difference between a first acquisition timestamp and a second acquisition timestamp, the first acquisition timestamp being an acquisition timestamp in the latest first spatial-temporal feature of the target object, and the second acquisition timestamp being a time difference between acquisition timestamps in the latest second spatial-temporal feature of the current global tracking object; and
determining a spatial-temporal similarity between the target object and the current global tracking object based on the positional relationship and the time difference.

7. The method according to claim 6, wherein the determining the spatial-temporal similarity between the target object and the current global tracking object comprises:
determining the spatial-temporal similarity between the target object and the current global tracking object based on a first target value based on the time difference being greater than a second threshold, the first target value being less than a third threshold;
based on the time difference being less than the second threshold and greater than zero, and the positional relationship indicating that the first image acquisition device and the second image acquisition device are the same device, obtaining a first distance between a first image acquisition region containing the target object in the first image acquisition device and a second image acquisition region containing the current global tracking object in the second image acquisition device, and determining the spatial-temporal similarity based on the first distance;
based on the time difference being less than the second threshold and greater than zero, and the positional relationship indicating that the first image acquisition device and the second image acquisition device are adjacent devices, performing coordinate conversion on each pixel of the first image acquisition region containing the target object in the first image acquisition device, to obtain a first coordinate in a first target coordinate system; performing coordinate conversion on each pixel of the second image acquisition region containing the current global tracking object in the second image acquisition device, to obtain a second coordinate in the first target coordinate system; and obtaining a second distance between the first coordinate and the second coordinate, and determining the spatial-temporal similarity based on the second distance; or
based on the time difference being equal to zero, and the positional relationship indicating that the first image acquisition device and the second image acquisition device are the same device; or based on the time difference being equal to zero, and the positional relationship indicating that the first image acquisition device and the second image acquisition device are adjacent devices but fields of view do not overlap; or based on the positional relationship indicating that the first image acquisition device and the second image acquisition device are non-adjacent devices, determining the spatial-temporal similarity between the target object and the current global tracking object based on a second target value, the second target value being greater than a fourth threshold.

8. The method according to claim 1, further comprising, after the obtaining the at least one image:
determining a set of images containing the target object from the at least one image, the set of images being acquired by at least two image acquisition devices that are adjacent devices among the plurality of image acquisition devices, wherein fields of view of the at least two image acquisition devices overlap;
converting coordinates of each pixel in images acquired by the at least two image acquisition devices into coordinates in a second target coordinate system;
determining, based on the coordinates in the second target coordinate system, a distance between target objects contained in the images acquired by the at least two image acquisition devices; and
determining that the target objects contained in the images acquired by the at least two image acquisition devices are the same object based on the distance being less than a target threshold.

9. The method according to claim 8, further comprising, before the converting:
caching the images acquired by the at least two image acquisition devices in a first period of time, and generating a plurality of trajectories associated with the target object;
obtaining a trajectory similarity between any two of the plurality of trajectories; and
based on the trajectory similarity being greater than or equal to a fifth threshold, determining that data acquired by the at least two image acquisition devices is not synchronized.

10. The method according to claim 1, further comprising, before the obtaining the at least one image:
obtaining images acquired by image acquisition devices in a location in which the at least one image acquisition device is installed; and
based on the global tracking object queue being not generated, constructing the global tracking object queue based on the images acquired by the image acquisition devices in the location.

11. An object tracking apparatus, comprising:
at least one memory configured to store program code; and
at least one processor configured to read the program code and operate as instructed by the program code, the program code comprising:
first obtaining code configured to cause at least one of the at least one processor to obtain at least one image acquired by at least one image acquisition device, the at least one image comprising a target object;
second obtaining code configured to cause at least one of the at least one processor to obtain, based on the at least one image, a first appearance feature of the target object and a first spatial-temporal feature of the target object;
third obtaining code configured to cause at least one of the at least one processor to obtain an appearance similarity and a spatial-temporal similarity between the target object and each global tracking object in a currently recorded global tracking object queue, the appearance similarity being a similarity between the first appearance feature of the target object and a second appearance feature of a global tracking object, and the spatial-temporal similarity being a similarity between the first spatial-temporal feature of the target object and a second spatial-temporal feature of the global tracking object;
allocation code configured to cause at least one of the at least one processor to allocate, based on determining that the target object matches a target global tracking object in the global tracking object queue based on the appearance similarity and the spatial-temporal similarity, a target global identifier corresponding to the target global tracking object to the target object;
first determining code configured to cause at least one of the at least one processor to determine, based on the target global identifier, a plurality of images acquired by a plurality of image acquisition devices, the plurality of images being associated with the target object; and
generation code configured to cause at least one of the at least one processor to generate, based on the plurality of associated images, a tracking trajectory matching the target object.

12. The apparatus according to claim 11, wherein the generation code comprises:
fourth obtaining code configured to cause at least one of the at least one processor to obtain a third spatial-temporal feature of the target object in each of the plurality of associated images;
arranging code configured to cause at least one of the at least one processor to arrange the plurality of associated images based on the third spatial-temporal feature to obtain an image sequence; and
marking code configured to cause at least one of the at least one processor to mark, based on the image sequence, a position where the target object appears in a map corresponding to a location in which the at least one image acquisition device is installed, to generate the tracking trajectory of the target object.

13. The apparatus according to claim 12, wherein the program code further comprises:
first display code configured to cause at least one of the at least one processor to display the tracking trajectory after marking the position where the target object appears in the map, the tracking trajectory comprising a plurality of operation controls, and the plurality of operation controls having a mapping relationship with the position where the target object appears; and
second display code configured to cause at least one of the at least one processor to display, in response to an operation performed on an operation control of the plurality of operation controls, an image of the target object acquired at a position indicated by the operation control.

14. The apparatus according to claim 11, wherein the program code further comprises:
processing code configured to cause at least one of the at least one processor to, with respect to each global tracking object in the global tracking object queue:
perform weighted calculation on the appearance similarity and the spatial-temporal similarity of a current global tracking object to obtain a current similarity between the target object and the current global tracking object; and
determine that the current global tracking object is the target global tracking object based on the current similarity being greater than a first threshold.

15. The apparatus according to claim 14, wherein the processing code is further configured to cause at least one of the at least one processor to, prior to performing the weighted calculation:
obtain a second appearance feature of the current global tracking object;
obtain a feature distance between the second appearance feature and the first appearance feature; and
determine the feature distance as the appearance similarity between the target object and the current global tracking object.

16. The apparatus according to claim 14, wherein the processing code is further configured to cause at least one of the at least one processor to, prior to performing the weighted calculation:
determine a positional relationship between a first image acquisition device that obtains a latest first spatial-temporal feature of the target object and a second image acquisition device that obtains a latest second spatial-temporal feature of the current global tracking object;
obtain a time difference between a first acquisition timestamp and a second acquisition timestamp, the first acquisition timestamp being an acquisition timestamp in the latest first spatial-temporal feature of the target object, and the second acquisition timestamp being a time difference between acquisition timestamps in the latest second spatial-temporal feature of the current global tracking object; and
determine a spatial-temporal similarity between the target object and the current global tracking object based on the positional relationship and the time difference.

17. The apparatus according to claim 16, wherein the processing code is further configured to cause at least one of the at least one processor to determine the spatial-temporal similarity by performing:
determining the spatial-temporal similarity between the target object and the current global tracking object based on a first target value based on the time difference being greater than a second threshold, the first target value being less than a third threshold;
based on the time difference being less than the second threshold and greater than zero, and the positional relationship indicating that the first image acquisition device and the second image acquisition device are the same device, obtaining a first distance between a first image acquisition region containing the target object in the first image acquisition device and a second image acquisition region containing the current global tracking object in the second image acquisition device, and determining the spatial-temporal similarity based on the first distance;
based on the time difference being less than the second threshold and greater than zero, and the positional relationship indicating that the first image acquisition device and the second image acquisition device are adjacent devices, performing coordinate conversion on each pixel of the first image acquisition region containing the target object in the first image acquisition device, to obtain a first coordinate in a first target coordinate system; performing coordinate conversion on each pixel of the second image acquisition region containing the current global tracking object in the second image acquisition device, to obtain a second coordinate in the first target coordinate system; and obtaining a second distance between the first coordinate and the second coordinate, and determining the spatial-temporal similarity based on the second distance; or
based on the time difference being equal to zero, and the positional relationship indicating that the first image acquisition device and the second image acquisition device are the same device; or based on the time difference being equal to zero, and the positional relationship indicating that the first image acquisition device and the second image acquisition device are adjacent devices but fields of view do not overlap; or based on the positional relationship indicating that the first image acquisition device and the second image acquisition device are non-adjacent devices, determining the spatial-temporal similarity between the target object and the current global tracking object based on a second target value, the second target value being greater than a fourth threshold.

18. The apparatus according to claim 11, wherein the program code further comprises:
second determining code configured to cause at least one of the at least one processor to determine, among the at least one image, a set of images containing the target object, the set of images being acquired by at least two image acquisition devices that are adjacent devices among the plurality of image acquisition devices, wherein fields of view of the at least two image acquisition devices overlap;
conversion code configured to cause at least one of the at least one processor to convert coordinates of each pixel in images acquired by the at least two image acquisition devices into coordinates in a second target coordinate system;
third determining code configured to cause at least one of the at least one processor to determine, based on the coordinates in the second target coordinate system, a distance between target objects contained in the images acquired by the at least two image acquisition devices; and
fourth determining code configured to cause at least one of the at least one processor to determine, based on the distance being less than a target threshold, that the target objects contained in the images acquired by the at least two image acquisition devices are the same object.

19. The apparatus according to claim 18, wherein the program code further comprises:
cache code configured to cause at least one of the at least one processor to, prior to conversion by the conversion code, cache the images acquired by the at least two image acquisition devices in a first period of time, and generate a plurality of trajectories associated with the target object;
fifth obtaining code configured to cause at least one of the at least one processor to obtain a trajectory similarity between any two of the plurality of trajectories; and
fifth determining code configured to cause at least one of the at least one processor to determine, based on the trajectory similarity being greater than or equal to a fifth threshold, that data acquired by the at least two image acquisition devices is not synchronized.

20. A non-transitory computer-readable storage medium, the storage medium storing a program, which is executable by at least one processor to perform:
obtaining at least one image acquired by at least one image acquisition device, the at least one image comprising a target object;
obtaining, based on the at least one image, a first appearance feature of the target object and a first spatial-temporal feature of the target object;
obtaining an appearance similarity and a spatial-temporal similarity between the target object and each global tracking object in a currently recorded global tracking object queue, the appearance similarity being a similarity between the first appearance feature of the target object and a second appearance feature of a global tracking object, and the spatial-temporal similarity being a similarity between the first spatial-temporal feature of the target object and a second spatial-temporal feature of the global tracking object;
based on determining that the target object matches a target global tracking object in the global tracking object queue based on the appearance similarity and the spatial-temporal similarity, allocating a target global identifier corresponding to the target global tracking object to the target object;
based on the target global identifier, determining a plurality of images acquired by a plurality of image acquisition devices, the plurality of images being associated with the target object; and
generating, based on the plurality of associated images, a tracking trajectory matching the target object.
